(19) United States
(12) Patent Application Publication
(10) Pub. No.: US 2019/0316260 A1
(43) Pub. Date: Oct. 17, 2019

(54) COATING TREATMENT SOLUTION, METHOD OF PRODUCING THE SAME, AND METHOD OF PRODUCING COATING MATERIAL

(71) Applicant: DENSO CORPORATION, Kariya-city (JP)

(72) Inventors: Ken MATSUBARA, Kariya-city (JP); Jung Hwan HWANG, Nagakute-shi (JP)

(21) Appl. No.: 16/382,302

(22) Filed: Apr. 12, 2019

(30) Foreign Application Priority Data
Apr. 13, 2018 (JP) 2018-077337

(51) Int. Cl. C23C 22/62; C23C 22/68; H01F 1/24

(52) U.S. Cl. CPC C23C 22/62; H01F 10/20; H01F 1/24; C23C 22/68

(57) ABSTRACT

A method produces a coating treatment solution to be used for forming a ferrite film having a spinel type crystal structure MFe₂O₄ on a surface of a soft magnetic material. The coating treatment solution contains a solution having a metal element and Fe. The metal element becomes divalent cations in the solution. The method prepares a first solution containing the metal element M and Fe, prepares a second solution by adding an alkaline solution to the first solution in a non-oxidizing atmosphere. The method produces the coating treatment solution by using the second solution.

### CROSS-REFERENCE TO RELATED APPLICATION

This application is related to and claims priority from Japanese Patent Application No. 2018-77337 filed on Apr. 13, 2018, the contents of which are hereby incorporated by reference.

### TECHNICAL FIELD

The present disclosure relates to coating treatment solutions to be used for forming a ferrite film on a surface of a soft magnetic material, and relates to methods of producing coating treatment solutions and methods of producing coating materials.

### BACKGROUND

In general, insulation coated soft magnetic materials, e.g. steel plate, soft magnetic particles have been widely used as core materials. The core materials are commonly used in alternating magnetic fields so as to reduce an eddy current loss. For example, there has been used a magnetic powder core produced by pressing and molding magnetic core powder made of insulation coated soft magnetic particles.

To use an insulation coated material is made of non-magnetic silicon resin or non-magnetic salt of phosphate acid reduces a saturation magnetic flux density, etc. In order to avoid this, the soft magnetic member is coated with ferrite as an insulation magnetic material. A two liquid method is used, in which a reaction solution, made of an acid solution in which a metal salt, e.g. Fe and Mn has been dissolved, is sprayed onto soft magnetic particles. After this step, a potential of hydrogen, e.g. pH adjustment solution made of a NaOH aqueous solution is sprayed onto the surface of the soft magnetic particles so as to form a ferrite film having a spinel crystal structure (MFe₂O₄) on the surface of the soft magnetic particles.

The two liquid method previously described requires performing two preparation steps of mixing soft magnetic particles and a reaction solution mixed together, and then of supplying a pH adjustment solution to the mixture. Accordingly, the two liquid method previously described is less efficiency.

Another method uses a coating treatment solution so as to form the ferrite film (MFe₂O₄) on the surface of the soft magnetic particles. The coating treatment solution has been produced by adding urea into a reaction solution. Urea is hydrolyzed at not less than a predetermined temperature and generates ammonia. This method does not use both the reaction solution and the pH adjustment solution simultaneously, and can form a uniform ferrite film on the surface of the soft magnetic particles even if the soft magnetic particles contain irregularly shaped particles.

### SUMMARY

The present disclosure provides a method of producing a coating treatment solution of a one-component type having a desired pH value. The method suppress ferrite particles and iron oxide FeOOH, etc., from being generated in a solution when an amount of oxygen, or dissolved oxygen contained in the solution is reduced even if an alkaline pH adjustment solution is added to an acid reaction solution.

### BRIEF DESCRIPTION OF THE DRAWINGS

A preferred, non-limiting embodiment of the present disclosure will be described by way of example with reference to the accompanying drawings, in which:

FIG. 1 is a graph showing a relationship between a pH value of coating treatment solution, a composition or a concentration of manganese (Mn) and zinc (Zn) contained in a ferrite film according to an exemplary embodiment of the present disclosure;

FIG. 2A is a graph showing a pH potential diagram of manganese (Mn); and

FIG. 2B is a graph showing a pH potential diagram of zinc (Zn).

### DETAILED DESCRIPTION OF THE PREFERRED EMBODIMENTS

Hereinafter, various embodiments of the present disclosure will be described with reference to the accompanying drawings. In the following description of the various embodiments, like reference characters or numerals designate like or equivalent component parts throughout the several diagrams.

### EXEMPLARY EMBODIMENT

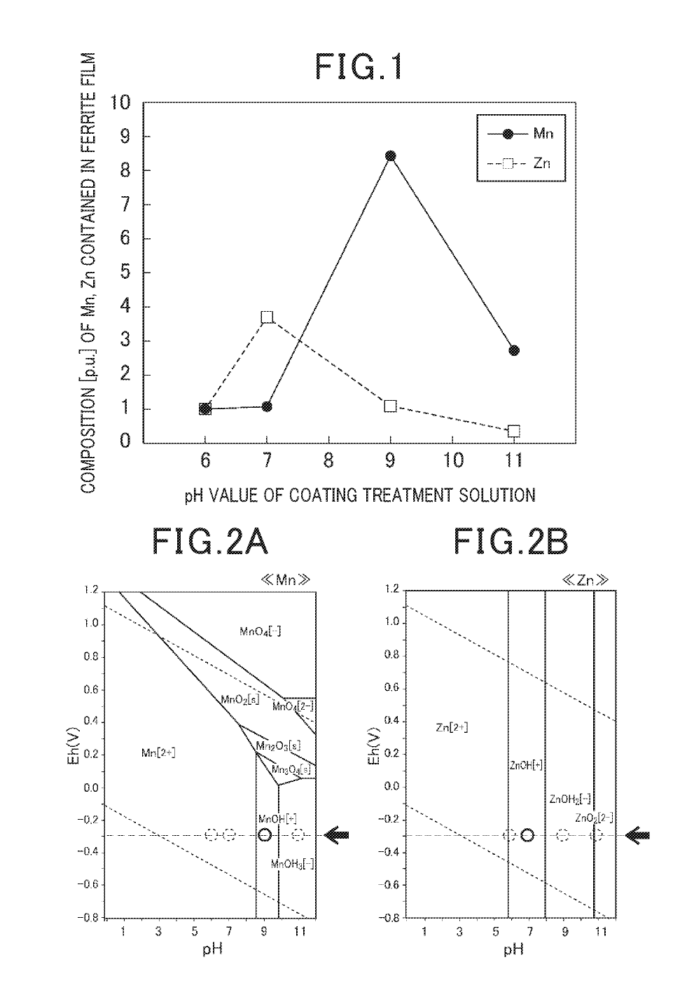

A description will be given of a coating treatment solution having a desired pH value, a method of producing the coating treatment solution and a method of producing coating materials according to an exemplary embodiment of the present disclosure with reference to FIG. 1, FIG. 2A and FIG. 2B.

### (Coating Treatment Solution)

It is possible to use, as a solvent, one of water, alcohol, etc. That is, it is possible to use one of an aqueous solution, an alcohol solution, etc. as the coating treatment solution according to the exemplary embodiment. The following description will use water as the representative example of the solvent.

### (c1) First Solution

A first solution contains at least a chemical element M and iron (Fe), For example, it is possible to dissolve various types of metal salt (metal chloride salt, sodium sulfate) into water as a solvent so as to prepare the first solution. The solution in which metal salt has been dissolved has a PH value within a range of 3 to 7, or a PH value within a range of 4 to 6. It is acceptable to use a single metal or multiple metals as the chemical metal M. For example, it is possible for the chemical metal M to have a high resistivity and a high magnetic flux density when M represents one of or both manganese (Mn) and zinc (Z).

### (c2) Second Solution

A second solution is produced by adding an alkaline solution into the first solution. The alkaline solution contains alkaline, e.g., sodium hydroxide (NaOH) or potassium hydroxide (KOH). For example, to drop an alkaline solution into the first solution makes it possible to adjust a pH value of the second solution to a desired pH value with high accuracy and high efficiency. For example, when a water solution is used as the first solution and the second solution, it is possible to perform a fine adjustment of a pH value of the second solution to a desired pH within a range of 7 to 12.

### (c3) Coating Treatment Solution

It is possible to use the second solution as the coating treatment solution, or to add a pH buffer agent and/or urea into the second solution. It is possible to use potassium acetate and ammonium acetate as the pH buffer agent. Because the hydrolysis of urea takes place at a temperature of not less than 80° C. and the result of the hydrolysis has alkali characteristics, it is possible to use an auxiliary agent of a pH adjustment. It is sufficient for the solution to have a molar concentration of urea which is 0.5 to 2 times of a total molar concentration of metal elements as metal ions (M²⁺, Fe²⁺) contained in the solution.

Further, it is acceptable for the coating treatment solution to contain a material and ions in addition to the materials previously described so long as it prevents a ferrite film from being formed.

### (Non-Oxidizing Atmosphere/Dissolved Oxygen)

Generation of ferrite particles in the solution is adjusted based on an oxidation reaction of Fe ions in the solution. This oxidation reaction depends mainly on a dissolved oxygen in the solution. Accordingly, it is possible to suppress generation of ferrite in the solution before contact with the soft magnetic material when an amount of the dissolved oxygens is reduced.

It is accordingly preferable to perform the second preparation step under the non-oxidizing atmosphere so as to obtain the second solution by adding an alkaline solution into the first solution.

Further, it is preferable to perform the first preparation step under the non-oxidizing atmosphere so as to prepare the first solution which contains M and Fe.

It is possible to use a glovebox so as to perform each of the first preparation step and the second preparation step in the non-oxidizing atmosphere. For example, the non-oxidizing atmosphere is an inert gas (Ar, N₂, etc.) atmosphere. Strictly speaking, the present disclosure uses the non-oxidizing atmosphere in which an oxygen concentration is not more than 10%, or more preferably not more than 5%. The oxygen concentration in the non-oxidizing atmosphere represents a volume percentage (VOL %) measured by an oxygen meter (or a O₂ meter, for example, XO-2200 manufactured by NEW COSMOS ELECTRIC CO., LTD) under 1 atm at normal temperature.

In order to reduce an amount of dissolved oxygen in the solution, it is preferable to perform a bubbling of a solvent and each of the first solution, the alkaline solution and the second solution under the inert gas atmosphere. It is preferable to perform the bubbling under the non-oxidizing atmosphere in a sealed vessel or container.

In order to suppress oxidation of Fe ions, it is preferable to dissolve a metal salt containing Fe into a solution, or to add or to mix a metal salt solution containing Fe into the solution after a metal salt containing M (excepting Fe) has been completely dissolved in the first preparation step.

It is preferable for the solution to have an oxygen dissolved concentration of not more than 4 ppm, or more preferably not more than 1 ppm. This oxygen dissolved concentration represents an amount of oxygen dissolved in the solution at normal temperature under 1 atm.

### (Coating Material/Magnetic Core Powder)

The present disclosure provides a magnet core powder including soft magnetic particles, the surface of which is coated with the ferrite file produced by using the coating treatment solution according to the present disclosure.

### (d1) Soft Magnetic Powder (Soft Magnetic Particles)

It is preferable for the soft magnetic powder to contain pure iron, or an iron alloy from the point of view of characteristics, availability and production cost. It is more preferably for the soft magnetic powder to substantially contain ferromagnetic elements, e.g. Fe, Co, Ni.

To use pure iron provides a high saturation magnetic flux density and increases magnetic characteristics of the magnetic powder core. For example, to use a Si-containing iron alloy as the iron alloy powder increases a resistivity of the magnetic powder core and reduces an eddy current loss because the presence of Si increases a resistivity of the magnetic powder core.

### (d2) Ferrite Film

It is possible to allow the magnetic powder core to have both features, the high resistivity and the high magnetic flux density when the ferrite film has a thickness within a range of 10 to 500 nm or within a range of 30 to 150 nm. In order to determine the thickness of the ferrite film, it is possible to detect a distribution of an oxygen amount on the surface of the coated particles based on Auger electron spectroscopy (AES) because the ferrite film is an oxide.

### (d3) Coating Treatment Steps

The present disclosure provides the coating treatment step of contacting the coating treatment solution according to the present disclosure with the soft magnetic particles so as to produce the magnetic powder core made of the soft magnetic particles, the surface of which has been coated with the spinel type ferrite.

For example, in the coating treatment step, the coating treatment solution is sprayed on the soft magnetic particles, which have been stirred or flowed, or sprayed on the heated soft magnetic particles. This makes it possible to form a uniform ferrite film on the surface of the soft magnetic particles.

In the coating treatment step, it is preferable to use the soft magnetic particles heated at a temperature within a range of 50 to 200° C., or more preferably within a range of 100 to 150° C.

When the coating treatment solution contains urea, it is preferable to use the soft magnetic particles heated at a temperature of not less than 80° C., or more preferably not less than 90° C.

The sprayed coating treatment solution is reacted with oxygen, etc. around the surface of soft magnetic particles, and consumed to form the ferrite film on the surface of the soft magnetic particles. It can be considered that the ferrite film is easily formed on the surface of the soft magnetic particles due to the dehydration of the metal oxide generated by the oxidation of Fe ions when the soft magnetic particles have been heated.

### (d4) Washing Step and Drying Step

It is preferable to perform a washing step so as to eliminate unnecessary materials from the soft magnetic powder after the coating treatment step. It is preferable for the washing step to use water and then to use ethanol. For example, the unnecessary materials are chlorine, sodium, sulfuric acid, and fine ferrite particles which have not been used for forming the ferrite film.

After filtering the soft magnetic powder which has been washed in the washing step, it is preferable to perform the drying step of drying the soft magnetic powder. It is sufficient for the drying step to perform a natural drying of the soft magnetic powder. It is preferable to heat the soft magnetic powder so as to dry the soft magnetic powder so as to produce the soft magnetic powder with high efficiency.

It is possible to perform a repetition of the coating treatment process and the washing step or the drying step according to a desired thickness of the ferrite film.

### EXEMPLARY EMBODIMENT

A description will be given of an exemplary embodiment according to the present disclosure with reference to FIG. 1, FIG. 2A and FIG. 2B.

### (Production of Magnetic Core Powder)

### (Production of Sample)

### (e1) Soft Magnetic Powder

A water atomized powder made of pure iron was prepared as the soft magnetic powder (as a raw powder).

The prepared water atomized powder had a particle size within a range of 106 μm to 212 μm. That is, the water atomized powder had an average particle size of 159 μm which is a median value between the upper limit value and the lower limit value of a mesh size of an electromagnetic sieve shaker (manufactured by Retsch).

If the soft magnetic powder does not contain soft magnetic particles having a particle size of less than 30 μm, it is possible to detect the average particle size of the soft magnetic particles by using a scanning electron microscope (SEM). The soft magnetic powder had a density of 2.5 g/cm³ and was composed of irregularly shaped particles.

### (e2) Coating Treatment Solution

The coating treatment solution (as the second solution) having a desired pH value was prepared by dropping a NaOH aqueous solution (alkaline solution) into a metal salt solution (as the first solution). The metal salt solution was produced by dissolving a metal salt composed of Fe and one of Mn and Zn into pure water.

Pure water used for preparing the metal salt solution and the NaOH aqueous solution has been bubbled not less than twenty minutes under inert gas (N₂) atmosphere.

The metal salt solution had a molar ratio of the metal elements (ions), i.e. Fe:Mn=2:1, or Fe:Zn=2:1. The metal salt solution had a concentration of 6.8 mmol/L.

The NaOH aqueous solution had a concentration of 3 mass % (NaOH: 3 mass % in the overall of 100 mass %).

FIG. 1 is a graph showing a relationship between a pH value of the coating treatment solution, a composition (concentration) of Mn and Zn contained the ferrite film according to the exemplary embodiment of the present disclosure.

As shown in FIG. 1, the exemplary embodiments prepared a plurality of pH treatment solutions having a pH value of 6, 7, 9 and 11. A low concentration of NaOH needs to consume a period of time to adjust the pH value. On the other hand, a high concentration of NaOH causes a drastic variation of a pH value. This makes it difficult to adjust the pH value with high accuracy. It is accordingly preferable to use a NaOH aqueous solution having a concentration within a range of 2 to 4 mass %.

The adjustment of each solution was performed by using a glovebox so as to perform in a non-oxidizing atmosphere. A nitrogen flow (N₂ flow) was used as the non-oxidizing atmosphere. It was detected that the oxygen concentration was not more than 5% in the non-oxidizing atmosphere by using an oximeter or an oxygen meter (XO-2200 manufactured by NEW COSMOS ELECTRIC CO., LTD). Iron salt was dissolved at a final stage in the preparation of the metal salt solution.

### (e3) Coating Treatment Step

The soft magnetic powder was thrown into a high speed mixer (manufactured by EARTH TECHNICA CO., LTD), and then stirred at a rotation speed of 3.5 m/sec while heating the soft magnetic powder at 140° C. (which is a treatment temperature). A temperature of the soft magnetic powder, i.e. the treatment temperature was detected by using a thermocouple arranged in a chamber of the high speed mixer.

While the soft magnetic powder was heated and stirred, each of the coating treatment solution containing a different metal or having a different pH value was sprayed into the soft magnetic powder. A needle spray gun (or a spray nozzle) was used so as to continuously spray each coating treatment solution to the soft magnetic powder at an air flow of A fluorine resin tube made of polytetrafluoroethylene was used so as to perform a force supplying of the coating treatment solution to the needle spray gun through a pipe. This prevents external oxygen from entering the coating treatment solution.

### (e4) Washing Step and Drying Step

After the coating treatment step, the soft magnetic powder was washed by using water and ethanol and filtered (Washing step). This makes it possible to remove chlorine (Cl) and residue remaining on the surface of the particles after the coating treatment step from the soft magnetic powder. The obtained soft magnetic powder was heated at a temperature of 80° C. by using a mantle heater.

### (e5) Selection Step

The soft magnetic powder after the drying step was filtered by using a sieve shaker having a 30 μm mesh size. The selection step removes ferrite particles not contributing to the coating of the soft magnetic particles. This makes it possible to produce the magnetic core powder made of the soft magnetic particles (or coated particles) coated with the ferrite particles which have been processed by using each coating treatment solution.

### (Observation and Measurement)

(f1) The surface of the coated particles was measured by using a X ray diffraction detection (XRD) method so as to recognize that the film formed on each soft magnetic particle was made of spinel type ferrite (MFe₂O₄ M=Mn, Zn).
(f2) A composition (atom ratio) of Mn and Zn contained in the ferrite film formed on each soft magnetic particle was measured by using the energy dispersive X-ray spectrometry (EDX) in the SEM (previously described). FIG. 1 shows the relationship between the pH value of the coating treatment solution and a composition of Mn, Zn in the ferrite film formed on each soft magnetic particle. That is, FIG. 1 shows the chemical composition representing a ferrite composition contained in the ferrite film. As can be clearly understood, a Mn—Zn ferrite film is formed around the pH value of 9 when a pH value is within a range of 8 to 11 or more preferably a pH value of 9.

### SUMMARY

(g1) As can be clearly understood from the results shown in FIG. 1 that it is possible to vary a content of metal element (M=Mn, Zn) contained in the ferrite file formed on the soft magnetic particles by adjusting a pH value of the coating treatment solution. For example, when the pH value of the coating treatment solution is changed from 7 to 9, the content of Mn can be changed by a factor of approximately 8.
(g2) FIG. 2A is a graph showing a pH potential diagram of manganese (Mn). FIG. 2B is a graph showing a pH potential diagram of zinc (Zn). As shown in FIG. 2A and FIG. 2B, Mn becomes MnOH⁺ near the pH of 9, and Zn becomes ZnOH⁺ near the pH of 7 at −0.3 V equipotential lines.

It is possible to form the uniform ferrite film having desired thickness and composition on the surface of the soft magnetic particles by matching the coating treatment solution having a desired pH value with the metal hydroxide ions (MOH⁺) to be used for forming the uniform ferrite film.

A method according to a related art of adding urea into a reaction solution prepares a solution having a constant pH value of approximately 7.5. This method is difficult to adjust a pH value of the solution according to varying a content of the metal element (M). On the other hand, the present disclosure previously described uses an alkaline solution (a NaOH aqueous solution, etc.) so as to directly adjust a PH value of the coating treatment solution to a desired value by reducing a dissolved oxygen amount in the coating treatment solution. To use the coating treatment solution according to the present disclosure makes it possible to form the ferrite film having a desired composition.

Incidentally, insulation coated soft magnetic materials (e.g. steel plate, soft magnetic particles) have been widely used as core materials. The core materials are commonly used in alternating magnetic fields so as to reduce an eddy current loss. For example, there has been used a magnetic powder core produced by pressing and molding magnetic core powder made of insulation coated soft magnetic particles.

To use an insulation coated material is made of non-magnetic silicon resin or non-magnetic salt of phosphate acid reduces a saturation magnetic flux density, etc. In order to avoid this, there is a related art which discloses a method of forming a ferrite coated film. The soft magnetic member is coated with ferrite as an insulation magnetic material.

There is a two liquid method according to a related art, in which a reaction solution, made of an acid solution in which a metal salt, e.g. Fe and Mn has been dissolved, is sprayed onto soft magnetic particles. After this step, a potential of hydrogen, e.g. pH adjustment solution made of a NaOH aqueous solution is sprayed onto the surface of the soft magnetic particles so as to form a ferrite film having a spinel crystal structure (MFe₂O₄) on the surface of the soft magnetic particles.

The two liquid method previously described requires performing two preparation steps of mixing soft magnetic particles and a reaction solution mixed together, and then of supplying a pH adjustment solution to the mixture. Accordingly, the two liquid method previously described is less efficiency.

Another method according to a related art uses a coating treatment solution so as to form the ferrite film (MFe₂O₄) on the surface of the soft magnetic particles. The coating treatment solution has been produced by adding urea into a reaction solution. Urea is hydrolyzed at not less than a predetermined temperature and generates ammonia. This method does not use both the reaction solution and the pH adjustment solution simultaneously, and can form a uniform ferrite film on the surface of the soft magnetic particles even if the soft magnetic particles contain irregularly shaped particles.

However, because the coating treatment solution containing urea is an acidic solution at normal temperature, a pH of the coating treatment solution varies when heated on the surface of the soft magnetic particles. Accordingly, it is difficult to adjust a pH of the coating treatment solution with high accuracy during the formation of the ferrite film on the surface of the soft magnetic particles. Further, it is difficult to adjust the pH of the coating treatment solution to not less than eight pH (≥8) by increasing an addition amount of urea. This means that hydroxyl group (OH⁻) is generated when ammonia (NH₃) generated by hydrolysis of urea is dissolved in water, and the generated hydroxyl group (OH⁻) is consumed by generating iron oxide (FeOOH), etc., and accordingly, and does not contribute to increase of a pH value of the coating treatment solution.

On the other hand, as previously described in detail, the present disclosure provides the coating treatment solution having a desired pH value as a one-component type coating treatment solution, the method of producing the coating treatment solution and the method of producing coating materials. The coating treatment solution and the methods according to the present disclosure solve the problems previously described,

### (Method of Producing the Coating Treatment Solution)

(a1) The present disclosure shows a method of producing the coating treatment solution to be used for forming a ferrite film having a spinel type crystal structure (MFe₂O₄) on a surface of a soft magnetic material. The coating treatment solution is made of a solution containing a metal element (M) of a divalent cation and Fe. The method has a first preparation step and a second preparation step. The first preparation step produces a first solution containing M and Fe. The second preparation step produces a second solution by adding an alkaline solution into the first solution in a non-oxidizing atmosphere. The second preparation step uses the second solution so as to produce the coating treatment solution.
(a2) The method of producing the coating treatment solution according to the present disclosure makes it possible to produce the one-component type coating treatment solution having a desired pH value while suppressing generation of ferrite particles because an alkaline solution (NaOH solution) is added into the first solution which contains M and Fe in at least a non-oxidizing atmosphere.

For example, to use the coating treatment solution produced by the method previously described according to the present disclosure allows the soft magnetic material to be coated with the ferrite film containing a metal element (M) with a high concentration in addition to Fe. Further, the method according to the present disclosure makes it possible to form a uniform ferrite film on the surface of soft magnetic particles (as the soft magnetic material) even if the soft magnetic particles are irregularly shaped particles (which are substantially non-spherical particles).

The method of producing the coating treatment solution according to the present disclosure has the following superior features.

In general, when an alkaline solution is added into an acid solution which contains M and Fe to produce a mixture solution, fine ferrite particles are generated in the mixture solution. Even if the mixture solution containing file ferrite particles is sprayed onto a soft magnetic material, no ferrite film is formed on the soft magnetic material. In order to avoid this drawback, a two component type method is used so as to form the ferrite film on the soft magnetic material.

On the other hand, the method according to the present disclosure makes it possible to produce the second solution in which generation of ferrite particles and iron oxide (FeOOH) has been drastically prevented because of performing the second preparation step in at least non-oxidizing atmosphere. That is, the ferrite particles are not generated when the alkaline solution has been added into the acid solution which contains M and Fe, but the ferrite particles have been generated due to the oxidation (Fe2⁺-->Fe3⁺) of Fe ions (in the dissolved oxygen) in the solution.

Further, the method according to the present disclosure produces the second solution which contains metal hydroxide ions (MOH⁺) which have been changed from the metal element ions (M²⁺). Accordingly, after the metal element ions (M²⁺) have been adhered on the surface of the soft magnetic material, the metal element ions (M²⁺) are oxidized by ambient oxygens and dehydrated, and are finally changed to a spinel type ferrite film (MFe₂O₄).

### (Coating Treatment Solution)

The present disclosure provides the coating treatment solution containing Fe and a metal element (M) to become divalent cations. The coating treatment solution according to the present disclosure is used for forming a ferrite film made of a spinel type crystal structure (MFe₂O₄) on the surface of a soft magnetic material. It is acceptable for the coating treatment solution to contain M and Fe and to have a pH value within a range of 7 to 12, and more preferably within a range of 7.6 to 11.

### (Method of Producing Coating Treatment Material)

The present disclosure provides the method of producing a coating treatment material by using the coating treatment solution. For example, it is acceptable for the method of producing the coating treatment material to have a step of bringing the soft magnetic material and the coating treatment solution produced by the method previously described into contact together. This makes it possible to form the ferrite film of the spinel type (MFe₂O₄) on the surface of the soft magnetic material.

### (Coating Treatment Material, Magnetic Core Powder and Magnetic Powder Core)

The present disclosure provides a coating treatment material produced by the method previously described. For example, the present disclosure provides a magnetic core powder (as the coating treatment material), the surface of which is coated with the ferrite film. The magnetic core powder is made of the soft magnetic particles (as the soft magnetic material) on which the ferrite film is coated. The present disclosure provides the magnetic powder core produced by pressing and molding the magnetic core powder.

### Other Modifications

(b1) The present disclosure uses a spinel type ferrite which is a cubic system soft ferrite represented by the chemical formula of MFe₂O₄ (MO.Fe₂O₃), where M represents a metal element, to become divalent cations, e.g. Mn, Zn, Mg, Cu, Ni, Sr, (Fe). That is, it is acceptable for M to be a combination of one or more of Mn, Zn, Mg, Cu, Ni, Sr, (Fe). It is also acceptable to use, as the ferrite, a magnetite (Fe₃O₄) in which M is Fe.
(b2) It is possible for the present disclosure to use the soft magnetic material of a plate shape or to use soft magnetic particles as the soft magnetic material. It is possible to use any material as the soft magnetic material as long as it is a magnetic material. Normally, the soft magnetic material contains group 8 elements (Fe, Co, Ni) having more than 50 atom % content to the overall content of the soft magnetic material). In particular, it is preferable for the soft magnetic material to have pure iron, or an iron alloy including metal elements (Si, Al, etc.) within a range of 1 to 10 mass %.
(b3) Through the description, the term (x to y) represents a lower limit value x and an upper limit value y. It is acceptable to determine a specific range (a to b) which represents as variables the lower limit value and the upper limit value.

While specific embodiments of the present disclosure have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present disclosure which is to be given the full breadth of the following claims and all equivalents thereof.

What is claimed is:

1. A method of producing a coating treatment solution comprising a solution containing a metal element M and iron, the metal element becoming divalent cations, the coating treatment solution being used for forming a ferrite film having a spinel type crystal structure MFe₂O₄ on a surface of a soft magnetic material, comprising steps of:
preparing a first solution which contains the metal element M and iron;
preparing a second solution by adding an alkaline solution to the first solution in a non-oxidizing atmosphere; and
producing the coating treatment solution by using the second solution.

2. The method of producing a coating treatment solution according to claim 1, wherein
the first solution is prepared in the non-oxidizing atmosphere.

3. The method of producing a coating treatment solution according to claim 1, wherein
the step of preparing the first solution performs one of:
a metal salt containing Fe is dissolved into a solution containing a metal salt which contains the metal element M; and
a solution containing a metal salt which contains Fe is mixed together with a solution containing a metal salt which contains the metal element M.

4. The method of producing a coating treatment solution according to claim 2, wherein
the step of preparing the first solution performs one of:
a metal salt containing Fe is dissolved into a solution containing a metal salt which contains the metal element M; and
a solution containing a metal salt which contains Fe is mixed together with a solution containing a metal salt which contains the metal element M.

5. The method of producing a coating treatment solution according claim 1, wherein
a solvent to be used for preparing at least one of the solutions including the first solution and the second solution is bubbled by using an inert gas in the non-oxidizing atmosphere.

6. The method of producing a coating treatment solution according to claim 2, wherein
a solvent to be used for preparing at least one of the solutions including the first solution and the second solution is bubbled by using an inert gas in the non-oxidizing atmosphere.

7. The method of producing a coating treatment solution according to claim 1, wherein
the first solution and the second solution are an aqueous solution, and
the second solution has a pH within a range of 7 to 12.

8. The method of producing a coating treatment solution according to claim 2, wherein
the first solution and the second solution are an aqueous solution, and
the second solution has a pH within a range of 7 to 12.

9. The method of producing a coating treatment solution according to claim 1, wherein
the coating treatment solution further contains a pH buffer agent and/or urea.

10. The method of producing a coating treatment solution according to claim 2, wherein
the coating treatment solution further contains a pH buffer agent and/or urea.

11. A method of producing a coating material comprising a step of contacting the coating treatment solution produced by the method according to claim 1 with a soft magnetic material so as to form a ferrite film of the spinel type crystal structure MFe₂O₄ on a surface of the soft magnetic material.

12. The method of producing the coating material according to claim 11, wherein
the soft magnetic material is soft magnetic particles, and the coating material is a magnetic core powder made of the soft magnetic particles, surfaces of which are covered with the ferrite film.

13. A coating treatment solution comprising a solution containing a metal element M and iron, the metal element becoming divalent cations, and the coating treatment solution being used for forming a ferrite film having a spinel type crystal structure MFe₂O₄ on a surface of a soft magnetic material, and the coating treatment solution containing the metal element M and iron and having a pH within a range of 7 to 12.

14. The coating treatment solution according to claim 13, wherein the coating treatment solution has a dissolved oxygen having a concentration of dissolved oxygen of not more than 10%.
